(19) United States
(12) Patent Application Publication
(10) Pub. No.: US 2005/0262196 A1
(43) Pub. Date: Nov. 24, 2005

(54) System and method for building and providing a universal product configuration system for arbitrary domains

(75) Inventor: Karl R. Mueller, Saratoga Springs, NY (US)

Correspondence Address: WILLIAMS MULLEN, 8270 GREENSBORO DRIVE, SUITE 700, MCLEAN, VA, 22102, US

(73) Assignee: Quote Tech, Inc.

(21) Appl. No.: 11/134,900

(22) Filed: May 23, 2005

Related U.S. Application Data
(60) Provisional application No. 60/573,569, filed on May 21, 2004.

(51) Int. Cl. G06F 15/177; G06F 15/16

(52) U.S. Cl. 709/203; 709/220; 709/219

(57) ABSTRACT

A system and method for building and providing a universal product configuration system for arbitrary domains allows one or more domain experts to create and maintain domain-specific conceptual frameworks and associated knowledge sets such that users can select and configure valid products and generate meaningful output. Multiple domains can be represented simultaneously, allowing multiple conceptual framework/knowledge set pairs to be used in any combination so that products from their respective conceptual frameworks can be shared within and across domains. The present invention further allows products to be converted and imported from legacy data sources, and provides for the standardization of product configuration systems, including the critical data embodied therein, within a single domain as well as across arbitrary multiple domains.

### CROSS-REFERENCE TO RELATED APPLICATIONS

This application claims the benefit of U.S. provisional patent application Ser. No. 60/573,569, filed May 21, 2004 and entitled “A System and Method for Building Valid Object Selection/Configuration Systems for Arbitrary Domains”, the disclosure of which is incorporated herein by reference.

### FIELD OF THE INVENTION

The present invention relates generally to product configuration systems, and more specifically to a system and method for building and providing a universal product configuration system for one or more arbitrary domains.

### BACKGROUND OF THE INVENTION

Various product configuration systems have been in use for years. An example of a product configuration system is a customized quoting system for the millwork industry such as the Marvin Quote System™ for Marvin Windows & Doors™ and Edgenet's m2o® (“made to order”) for Andersen Windows and Doors™. Typically, product configuration systems are comprised of custom software systems (e.g., window & door quote systems) that must be individually crafted by software engineers for any given domain (e.g., window and door manufacturer's product line). In other cases, product configuration systems are generated in a more reusable fashion but have an extra level of complexity in communicating with each other and difficulty sharing data. In still other cases, no such automated software system exists, thereby necessitating a completely manual process.

Some of the main problems with conventional product configuration systems are that they are costly and time consuming, often requiring the expertise of software engineers to develop and maintain. Other problems with conventional product configuration systems are that none of these types of systems interoperate and share data with one another, necessitating the use of applications from different vendors. As an example, if a customer desired to purchase a Marvin™ double hung window and an Anderson™ casement window, then the salesperson for the customer would need to use both the custom quote system for the Marvin™ product line as well as the one for Anderson™. Another problem with conventional product configuration systems is that the outputs (e.g., reports) that are generated are “hard-coded” and cannot be augmented with new content or modified without the expertise of software engineers. Another problem with conventional product configuration systems is that it is difficult and complex, if even possible, to import the output of these systems into other systems in the market, such as accounting packages, database management systems, and so forth. It is further problematic that such conventional systems do not allow an easy vehicle for standardization either within a particular domain, much less across multiple domains.

While the above systems may be suitable for their particular purpose, they are not as suitable for providing a platform that allows domain experts to create, contribute to, maintain and offer conceptual frameworks and their associated knowledge sets that completely describe the objects and their associated attributes for a particular domain(s), and which can be subsequently used by a product configuration system(s) in specifying a full product representation including valid selection options. Nor do they allow users to select valid products and their associated attributes and then generate meaningful output (e.g., pre-defined and ad hoc reports for the selected object(s)), without the need for programming in code. Nor do they allow users to select valid objects and their associated attributes across multiple arbitrary domains.

### SUMMARY OF THE PRESENT INVENTION

In these respects, a system and method for building a universal product configuration system for arbitrary domains according to the present invention substantially departs from the conventional concepts and designs of the prior art. In so doing, the present invention provides a platform allowing a domain expert to create and maintain a conceptual framework and its associated knowledge set for a particular domain, which is then subsequently used by a product configuration system, without the need of a software engineer. The present invention allows a domain expert, for example, to specify a conceptual framework and its associated knowledge set that completely represents a set of products, without the need of a software engineer, so as to completely describe available products and their associated attributes. Furthermore, the present invention allows users of these systems to select valid objects and their associated attributes and to generate meaningful output, again without the need for programming in code. Additionally, this invention allows for objects to be converted and imported from legacy data sources, thus maintaining backward compatibility with legacy data. Further, a plurality of conceptual frameworks and their respective associated knowledge sets generated by this invention, each which represents a set of products, can be used in any combination within an instance of a product configuration system so that product(s) from their respective conceptual framework(s) can be shared within and across domains. Even further, the present invention provides for the standardization of product configuration systems, including the critical data they embody, within a single domain as well as across multiple arbitrary domains.

In view of the foregoing disadvantages inherent in the known types of product configuration systems (e.g., quote systems for window & door manufacturers, manual systems), the present invention provides a new system and method for building and providing universal product configuration systems for arbitrary domains. The present invention provides, in one aspect, a platform that allows a domain expert (someone knowledgeable in a particular field (e.g., millwork industry)) to create and maintain a conceptual framework and its associated knowledge set for a particular domain (e.g., window and door manufacturer's product line), which is then subsequently used by a product configuration system, without the need of a software engineer. The present invention further provides a product configuration system, which can import a given conceptual framework and its associated knowledge set that completely describes the objects (i.e., products) and their associated attributes for a particular domain (e.g., window and door product line). The present invention even further provides a system allowing users to select and configure valid objects and their associated attributes and to generate meaningful output (e.g., pre-defined and ad hoc reports for the selected object(s)), again without the need for programming in code. Another important aspect of the present invention is that it allows objects to be converted and imported from legacy data sources, thus maintaining backward compatibility with legacy data. Further, another aspect of the present invention is its scalability, in that any conceptual framework and its associated knowledge set created by one domain expert can be shared (i.e., within any product configuration system) with other conceptual frameworks and their associated knowledge sets created by other domain experts. The present invention further allows the output to be easily imported into other systems, such as accounting packages, database management systems, and so forth.

The present invention accomplishes such objects and other objects by providing a Conceptual Frameworks/Knowledge Sets Generator, Conceptual Framework Builder, Knowledge Set Builder, Data Store for Conceptual Framework(s), Data Store for Knowledge Set(s), the System Controller, Dynamically Generated Interface(s), Interface Builder, Knowledge Engine, Output Engine(s) (e.g., Report Engine), Output(s) (e.g., Reports), Output Template Generator, Output Template(s), and Output Template Processor. Such components can be provided together in one embodiment of the invention, but it will be appreciated that selected ones of these components may be combined together in alternative embodiments of the present invention. Such components are described in greater detail hereafter.

In considering the present disclosure, it will be appreciated that the term “product” is not necessarily limited to physical goods, but can encompass systems, services, computer code, objects, abstract elements and/or any other valid element that may comprise a portion or entirety of a commercial offering.

The Conceptual Frameworks/Knowledge Sets Generator comprises two processes: the Conceptual Framework Builder and The Knowledge Set Builder. The Conceptual Framework Builder is a process that interacts with an entity such as a domain expert, for example, to create a conceptual framework for a particular domain (e.g., window and door manufacturer's product line), which completely defines the universe of valid products (e.g., windows, doors, etc.) and their associated attributes (which themselves may be objects) that may be selected from that domain. The Knowledge Set Builder is a process that interacts with an entity such as a domain expert, for example, to specify domain specific knowledge (e.g., business logic) that further constrains the universe of valid products and their associated attributes. The Data Store for a Conceptual Framework(s) provides a framework that specifies the data types, relationships between the data and constraints on the data. This framework can be object-based, in one embodiment, and as such also specifies relationships between products (e.g., hierarchical, part-of, etc.) as well as basic constraints for valid products and their attributes that may be constructed and then selected.

The Data Store for Knowledge Set(s) provides knowledge which specifies additional, more complex, constraints defined for products and their associated attributes from a particular domain that ensure that only valid products may be constructed.

The System Controller provides for importing and/or processing conceptual framework(s). This component also coordinates the functions of the Interface Builder, Knowledge Engine, and Output Engine(s) processes, as well as serializing/de-serializing selected products/attributes, allowing a user to select an Output Template, applying an output template via the Output Template Processor, and receiving/sending back data from/to the dynamically generated interfaces, for example.

The Dynamically Generated Interfaces are, in one embodiment, appropriate interface(s) that are generated on-the-fly from the Interface Builder, which allows a user to specify valid products and their associated attributes. The Interface Builder is a process that applies the conceptual framework for a particular domain and its associated knowledge (e.g., business logic) to dynamically generate an appropriate interface from which valid product(s) may be constructed and configured.

The Knowledge Engine can apply a knowledge set to a particular domain's conceptual framework to ensure that only valid products are constructed, for example. The Output Engine(s) (e.g., Report Engine) can provide a process that receives valid products/attributes from the universe of valid products/attributes, as well as optionally additional contextual content, and generates meaningful output (e.g., reports) from them.

Output(s) (e.g., Reports) provides meaningful information representing the valid products/attributes selected from the universe of valid products for a particular domain, as well as optionally additional contextual content, which can be represented by any of the following, for example: text, XML document, PDF document, video stream, numerical, figures/drawings, animations, program executable, etc. The Output Template Generator is a process that allows the domain expert(s) and/or system user(s) to generate an output template(s). Output Template is a template that can then be applied to the selected products/attributes for the purpose of modifying the selected products/attributes and/or providing additional contextual content that will ultimately be processed by the Output Engine in order to generate the desired Output.

The Output Template Processor provides a process that can apply a template to the selected products/attributes in order to optionally modify the selected products/attributes as well as provide additional contextual content that will ultimately be processed by the Output Engine in order to generate the desired Output.

The Legacy Data Processor provides a process that converts legacy domain data (i.e., Legacy Data Source) into products that are compatible with the architecture of this invention, thus maintaining backward compatibility with legacy data.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

One object of the present invention is to provide a system and method for building a product configuration system for arbitrary domains that will overcome the shortcomings of the prior art devices.

Another object of the present invention is to provide a system and method for building a product configuration system for arbitrary domains which allows a domain expert to create custom conceptual frameworks and their associated knowledge sets for any domain(s), which can then be used within any instance of a product configuration system without the need of custom software or a software engineer.

Another object of the present invention is to provide a system and method whereby users of a provided product configuration system can import a conceptual framework and associated knowledge set, and thereafter select only valid products and their associated attributes, wherein the products may be arbitrarily complex.

Another object of the present invention is to provide a product configuration system that completely describes the products and their associated attributes for a particular domain and allows users of that system to select valid products and their associated attributes.

It is a further object of the present invention to provide a system wherein domain products can be specified as arbitrarily complex (e.g., multi-dimensional grouping of products).

Another object of the present invention is to provide a system and method for building a product configuration system for arbitrary domains that allows a domain expert to maintain and modify their custom conceptual frameworks and associated knowledge sets for any domain(s), which can then be used within any instance of a valid product selection and configuration system(s).

Another object of the present invention is to provide a system and method for building a product configuration system for arbitrary domains that allows a plurality of conceptual frameworks and their respective associated knowledge sets generated by an implementation of this invention, each which represents a set of products, to be used in any combination within an instance of a product configuration system so that product(s) from their respective conceptual framework(s) can be shared within and across domains.

Another object of the present invention is to provide a system and method for building a product configuration system for arbitrary domains that allows products to be converted and imported from legacy data sources, thus maintaining backward compatibility with legacy data.

Another object of the present invention is to provide a system and method for building a product configuration system for arbitrary domains that allows a user of a product configuration system to specify outputs (e.g., pre-defined and ad-hoc reports).

Another object of the present invention is to provide a system and method for a universal product configuration system for arbitrary domains that allows for the standardization of product configuration systems, as well as the critical data they embody, within a given domain and/or across multiple product domains.

Another object of the present invention is to provide a system and method for a universal product configuration system for arbitrary domains that will allow the output to be easily imported into external systems.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIGS. 1 through 6 show schematic diagrams depicting elements incorporated in one or more embodiments of the system of the present invention.

FIG. 7 shows a flow chart depicting operation of the present invention in connection with the Conceptual Frameworks/Knowledge Sets Generator.

FIGS. 8A and 8B depict a flow chart showing operations involved in one embodiment of the present invention.

FIGS. 9A and 9B are schematic diagrams showing an alternative representation of elements of the present invention.

### DETAILED DESCRIPTION OF THE PREFERRED EMBODIMENTS

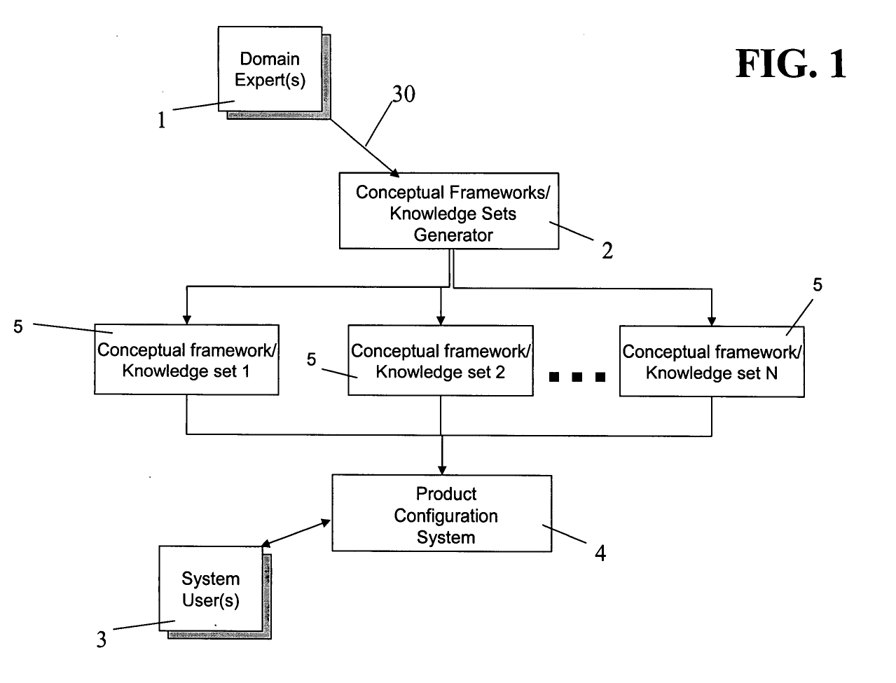

Turning now descriptively to the drawings, in which similar reference characters denote similar elements throughout the several views, the attached FIGS. 1-8B illustrate a first embodiment of a system and method for building product configuration systems for arbitrary domains in accordance with the present invention. As shown in FIGS. 1-6, the system can comprise a Conceptual Frameworks/Knowledge Sets Generator 2, Conceptual Framework Builder 15, Knowledge Set Builder 16, Data Store for Conceptual Framework(s) 6, Data Store for Knowledge Set(s) 7, the System Controller 8, Dynamically Generated Interface(s) 9, Interface Builder 10, Knowledge Engine 11, Output Engine(s) 12, Output(s) 13, Output Template Generator 17, Output Template(s) 18, and Output Template Processor 19. Such components can be provided together in one embodiment of the invention, but it will be appreciated that selected ones of these components may be combined together in alternative embodiments of the present invention.

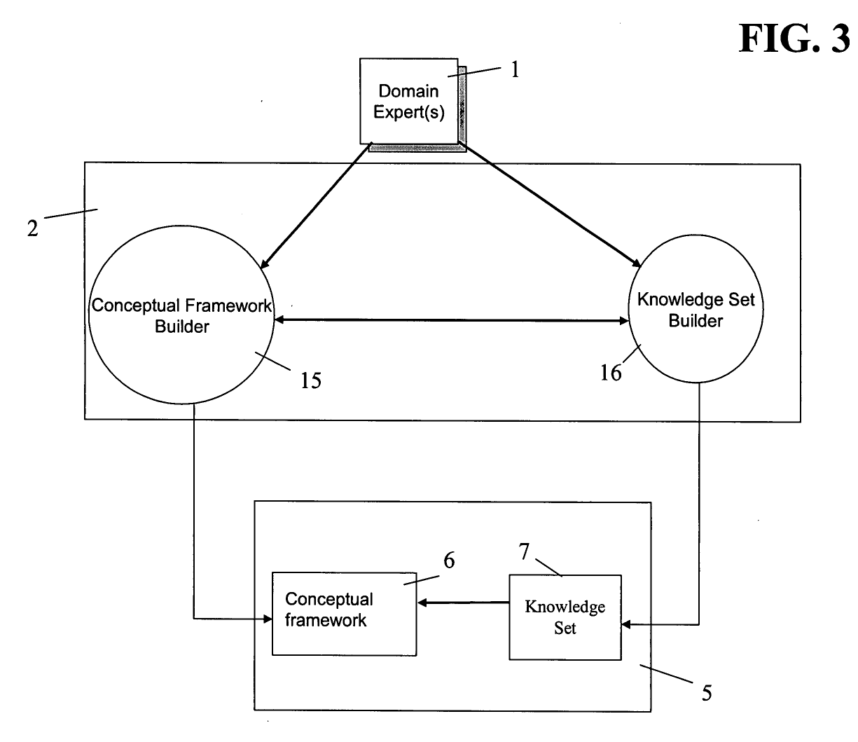

As shown in FIG. 1, at least one domain expert 1 submits framework and/or knowledge set information 30 specifying a product line and product domain knowledge into generator 2. As shown in FIG. 3, the Conceptual Frameworks/Knowledge Sets Generator 2 comprises two processes: the Conceptual Framework Builder 15 and the Knowledge Set Builder 16, which respectively allow the domain expert to create the conceptual framework 6 for a particular domain as well as specify the business logic (i.e., knowledge set 7). Knowledge set 7 adds additional constraints on the universe of valid products and their associated attributes, and conceptual framework and knowledge set together form a conceptual framework/knowledge set 5 as shown in FIG. 3. It will be appreciated that in the case of a product set resulting from a relatively simple domain, there may be no need for a knowledge set 7, since the conceptual framework 6 can specify the necessary basic constraints. In such a case, the domain expert can determine whether or not a knowledge set is required.

The Conceptual Framework Builder 15 provides a process, such as a computer-implemented process, that can interact with a domain expert 1 to create a conceptual framework 6 for a particular domain (e.g., window and door manufacturer's product line). Such a framework can completely define the universe of valid products/attributes that may be selected from that domain. For example, this process can generate the conceptual framework 6 (e.g., XML schema) for a window & door manufacturer's product line, which is naturally hierarchical in nature, as follows: 1. Allow the user to graphically add nodes in a hierarchical fashion from their product line (e.g., Clad→Windows→Double Hung Window); 2. For each leaf node (which represents an object as determined by the domain expert), allow the domain expert to specify the object's associated attributes and their data type (e.g., “Width” attribute which has a “float” data type); 3. Generate the corresponding XML schema, for example, by instantiating a parameterized version of the appropriate XML schema structure and/or data type (e.g.: <element name=“$NAME” type=“$TYPE” fixed=“$VALUE”/>→<element name=“Interior Finish” type=“string” fixed=“bare wood”/>)—similarly other more complex XML schema structures can be instantiated as well, such as “complexType”, “sequence”, “simpleContent”, etc.; and 4. Recursively apply step 2 and 3 to any of the child objects that are contained within the parent object and so forth.

The Knowledge Set Builder 16 provides a process, such as a computer-implemented process, that can interact with a domain expert 1 to specify domain specific knowledge 7 that further constrains the universe of valid products and their associated attributes. For each object and/or attribute which requires some special constraint, which the domain expert knows to exist, the knowledge set builder can allow the expert to: 1. Select the desired object or attribute via the Conceptual Framework Builder 15 which invokes this process by bringing up a dialog window which allows the domain expert to specify an appropriate If-Then rule, for example; 2. Allow the domain expert to specify both the If “condition” and Then “action” for the corresponding constraint (e.g., IF “DoubleHungWindow.Width” is great than 50 THEN Display Message “Double hung window width may not be greater than 50”). There are commercially available graphical If-Then rule editors which can be integrated within this component to construct arbitrarily complex rules, for example. Anyone skilled in the art may substitute any process that interacts with a domain expert 1 to specify knowledge that provides additional constraints on this universe of products, attributes and their relations.

The Data Store for a Conceptual Framework(s) 6 provides a framework that specifies the data types, relationships between the data and constraints on the data. This framework can be object-based, for example, and as such can also specify relationships between objects (e.g., hierarchical, part-of, etc.) and basic constraints for valid products and their attributes that may be constructed and then selected. An example of a conceptual framework includes but is not limited to an XML schema(s), which has a very rich capability of specifying products, attributes and their relationships. Anyone skilled in the art may substitute any data model that specifies the aggregate of all the products, attributes, and relations assumed or implied for a particular domain.

The Data Store for Knowledge Set(s) 7 provides knowledge which specifies additional, more complex, constraints defined for products/attributes from a particular domain that ensure that only valid products may be constructed. An example of a knowledge set includes but is not limited to If-Then type rules that specify business logic that augment the conceptual framework in constraining the set of valid products/attributes that can be selected. One structural variation would be the use of a frame-based reasoning system. It is conceivable that someone skilled in the art could utilize any other form of deterministic and/or non-deterministic logic to represent additional more complex constraints (e.g., business logic).

It will be appreciated that the domain expert does not need to have any software expertise per se. Anyone skilled in the art may substitute any process that interacts with a domain expert 1 to generate a data model that specifies valid products/attributes from a particular domain that is paired with knowledge that specifies additional constraints on this universe of products, attributes and their relations. It will further be appreciated that the domain expert can be a person, computer system, computer program, or other entity capable of providing input to the present invention as disclosed herein.

Returning to FIG. 1, each constructed conceptual framework/knowledge set 5 can be generated and imported by a Product Configuration System 4 accessible by one or more system users as described more fully hereafter. The present invention contemplates that multiple such conceptual frameworks/knowledge sets 1 . . . N can be imported by a Product Configuration System(s) for the purpose of sharing derived valid objects, as illustrated in FIG. 1. Alternatively, each conceptual framework/knowledge set can be imported and used by an isolated product configuration system in another embodiment of the invention. In one embodiment of the invention, the domain expert can, in addition to providing conceptual framework and/or knowledge set information, provide instructions for customizing a product selection display for a user interface associated with the developed product configuration system. In other words, the domain expert can assist in how the information and selection options will be presented to a user of the developed product configuration system.

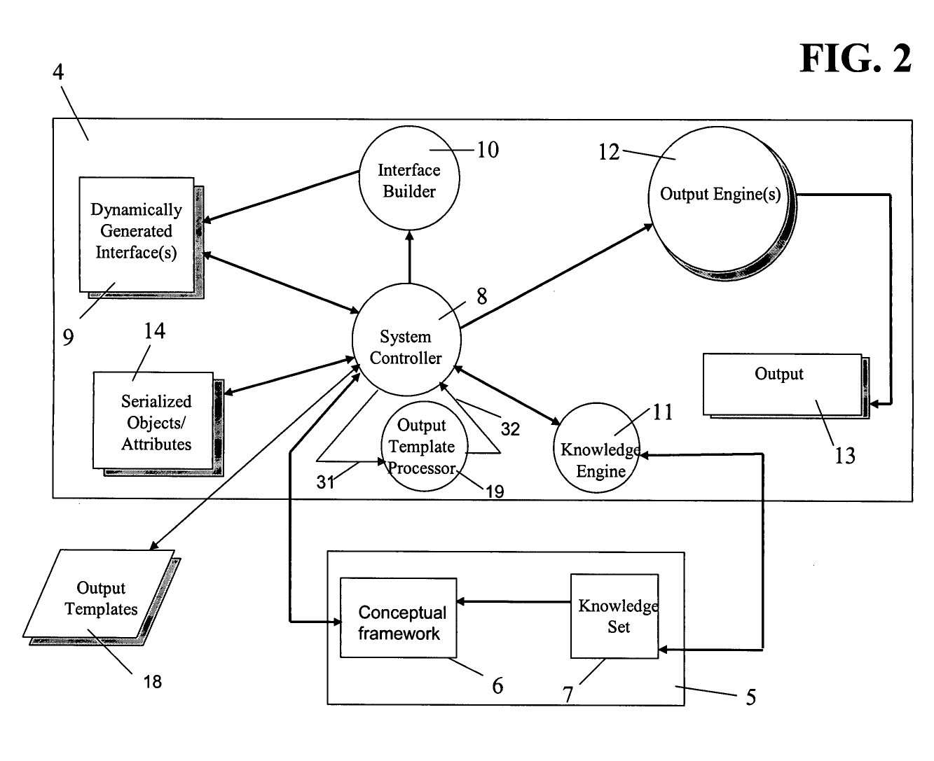

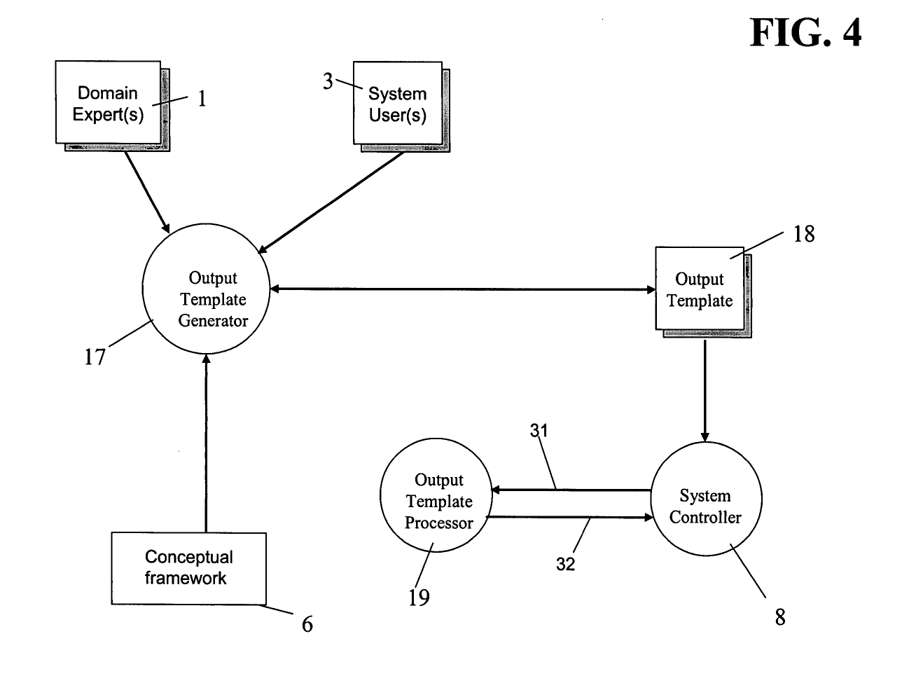

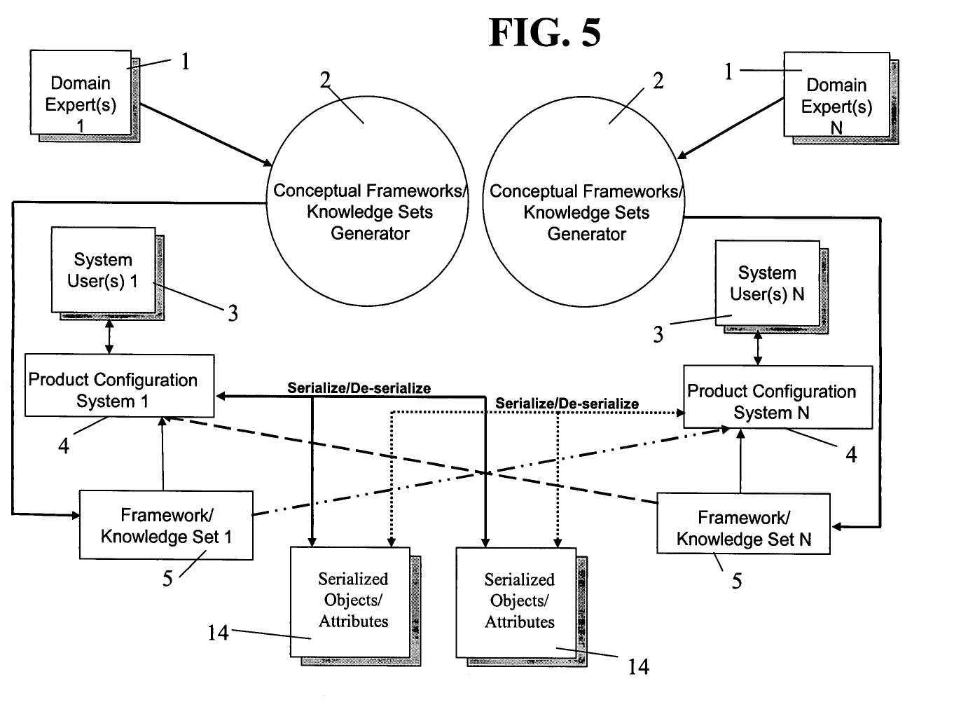

With reference to FIG. 2, the System Controller 8 can be provided at the center of an instance of a Product Configuration System 4, and this component can be responsible for importing/processing conceptual framework(s) 6. In one embodiment, this can be done by de-serializing the conceptual framework, which in the preferred embodiment is an XML schema document file or files, and then parsing it/them with a commercially available XML parser. As the user navigates the conceptual framework, the underlying schema file can be introspected in order to construct the corresponding product with all of its attributes, etc. In one embodiment, the System Controller 8 also performs the following functions: 1. Provides data on the current product within the conceptual framework and associated knowledge to the Interface Builder 10 so that an appropriate interface can be generated; 2. Receives user input from the Dynamically Generated Interface 9 as well as sends back data provided by this process or other processes (e.g., Knowledge Engine 11); 3. Provides information on the current product and its associated attributes (i.e., state information) to the Knowledge Engine 11 so that it can apply the appropriate knowledge; 4. Provides output data (i.e., selected products/attributes as well as optionally additional contextual content) to the Output Engine 12; 5. Allows the user to select a corresponding Output Template 18, which is then applied, via the Output Template Processor 19, to the selected products/attributes, in order to generate the desired Output 13 (see, e.g., FIG. 4); and 6. Allows the user to serialize/de-serialize selected products/attributes 14 (see, e.g., FIG. 5). One functional variation of the present invention is to have the System Controller 8 directly import the Knowledge Set 7 (as opposed to the Knowledge Engine 11 providing this function as illustrated in FIG. 2) and providing that knowledge to the Knowledge Engine 11. In addition, anyone skilled in the art may substitute any process that allows the coordination of the activities of the Interface Builder 10, Knowledge Engine 11, Output Template Processor 19, and Output Engine(s) 12 processes, or any of their functional or structural variations. Further, anyone skilled in the art may substitute any process that can provide the following functions or any of their functional or structural variations: serializing/de-serializing selected products/attributes 14, allowing a user to select an output template 18, and receiving/sending back data from/to the dynamically generated interfaces 9, respectively.

Dynamically Generated Interfaces 9 are appropriate interface(s), which allow a user to specify valid products that are generated on-the-fly from the Interface Builder 10. An example of a dynamic interface could be a graphical user interface that is a set of graphical widgets (e.g., text fields, combo boxes, pull-down menus, etc.) which are generated on-the-fly as the user navigates the associated conceptual framework. As the user navigates the universe of valid products, the graphical widgets are dynamically generated to reflect the current product. Thus, these graphical widgets directly correspond to a selected product and its associated set of valid attributes. Furthermore, the Knowledge Engine 11 can apply knowledge from the current Knowledge Set 7 which further constrains the valid product(s) and associated attributes that may be selected and this is also dynamically reflected in the set of graphical objects that are generated. One functional variation is to dynamically display a graphical representation (i.e., image) of the selected product and its attributes as the system user navigates the universe of valid products and their associated attributes; the information used to construct this image can be specified, for example, within the conceptual framework and augmented with knowledge from the associated knowledge set. Anyone skilled in the art may substitute any interface that allows a user to specify desired valid products/attributes from the aggregate of all the products, attributes, and relations assumed or implied for a particular domain.

The Interface Builder 10 is a process that applies the conceptual framework for a particular domain and its associated knowledge (e.g., business logic) to dynamically generate an appropriate interface from which valid product(s) may be constructed. The appropriate graphical widgets would be automatically determined by the corresponding selected object's XML schema structure(s) and then created: for example, if the corresponding XML schema structure indicated an enumeration of values, then a “combo-box” which contained those values would be presented to the user. Typically, the corresponding XML schema structure would be complex and in that case would necessitate recursively or iteratively navigating the schema's sub-structures in order to generate their associated graphical widgets as well. Anyone skilled in the art may substitute any process that generates an interface that allows a user to select products and their associated attributes from the aggregate of all the products, attributes, and relations assumed or implied for a particular domain.

As further shown in FIG. 2, the Knowledge engine 11 imports the Knowledge Set 7 associated with a particular Conceptual Framework 6 and applies this domain knowledge (e.g., business logic) to the domain's conceptual framework. Examples of a knowledge engine include but are not limited to a rule engine that is an existing commercial process that pattern matches rules that fit pre-determined criteria and executes those rules. Any existing rule engine or future implementation that has the capability to pattern match rules and dynamically execute those rules may be substituted. Furthermore, anyone skilled in the art may utilize any deterministic and/or non-deterministic logic engine, such as a frame-based reasoning system, that has the ability to specify additional logic that further constrains the valid product(s) and their associated attributes.

The Output Engine(s) 12 provides a process that receives valid products and their associated attributes from the universe of valid products/attributes, as well as optionally additional contextual content, and generates meaningful output (e.g., reports) from them. Examples of an output engine include but are not limited to the following: any commercially available Report Engine (e.g., InetSoft, Inc.'s Style Report™ engine), or a custom engine that can be plugged into the architecture to create any desired output, etc. Anyone skilled in the art may substitute any process that takes as input valid products and their attributes, as well as additional contextual content, and generates meaningful output based on this input data.

Output(s) 13 provide meaningful information representing the valid product(s) and their associated attributes selected from the universe of valid products/attributes, as well as optionally additional contextual content, which can be represented by any of the following: text, XML document, PDF document, video stream, numerical, figures/drawings, animations, program executable, etc. Anyone skilled in the art may substitute any output element that contains relevant information for a selected product(s) and its associated attributes as well as any additional contextual content.

With reference to FIG. 4, Output Template Generator 17 is a process that allows the domain expert(s) 1 and/or system user(s) 3 to generate an output template(s) 18. An important aspect of the present invention is that this component allows the user to specify template elements and operations without needing to understand the underlying grammar and syntax of an Output Template 18 per se. For example, this process would allow a domain expert to specify an output template in the following manner: 1. present a graphical table interface to the user where individual cells in the table may be selected and rows may be inserted or deleted where the relative positions of the table cells would map accordingly to the same relative positions within an actual report; 2. when a user selects a cell in the table open a dialog window which either allows the user to dynamically add/modify attributes for the desired element (e.g., customer address) as well as specify additional style specifications such as possible alignment values or to specify desired products/attributes from the Conceptual Framework(s) 6 for inclusion in the report; and 3. iterate through each cell in the table and create an appropriate schema construct which completely specifies a report element which is added to the Output Template(s) which in this case is an XML schema document. This process also allows a domain expert to serialize and de-serialize an output template so that it may be modified. Anyone skilled in the art may substitute any process that interacts with a domain expert 1 and/or a system user 3 to generate an output template or anything similar which when applied to the selected products/attributes could serve to modify the output in a meaningful manner.

An Output Template(s) 18 can then be applied to the selected products/attributes for the purpose of affecting the content of a particular type of Output 13. Changes to the output include but are not limited to modifying the selected products/attributes and/or adding additional contextual content. An example of an output template includes but is not limited to an XML schema document which specifies all the elements within a report as well as the objects and any of its desired attributes. Anyone skilled in the art may substitute a template or anything similar which when applied to the selected products/attributes could serve to modify the Output 14 in a meaningful manner.

The Output Template Processor 19 can apply an Output Template 18 to the selected products/attributes in order to optionally modify the selected products/attributes as well as provide additional contextual content that will ultimately be processed by the Output Engine 12 in order to generate the desired Output 13. For example, an output template could be applied in the following manner: 1. de-serialize the output template and parse it with a commercially available XML parser; 2. introspect the schema for its individual elements and if it is an additional contextual element, create an appropriate graphical interface to edit and subsequently instantiate the corresponding XML document element (e.g., customer address); 3. map any schema elements which have analogues in the conceptual framework 6 to the selected products/attributes and instantiate their corresponding XML elements; and 4. sequentially visit every node in the resulting XML document to make appropriate API calls to the output engine 12 (e.g., add customer name to the report). Anyone skilled in the art may substitute any process that can apply a template or any of its functional or structural variations to the selected products/attributes in order to either modify the selected products/attributes and/or add additional contextual content for the purpose of changing the Output 13. FIG. 4, illustrates that either the Domain Expert(s) 1 and/or System User(s) 3 may generate Output Template(s) 18 via the Output Template Generator 17. An Output Template can then be used to create pre-defined or ad hoc types of Output 13 when it is applied by the Output Template Processor 19 to the selected products/attributes. The system controller 8 can provide the output template, object data and any additional data (e.g., customer information) as indicated at 31, and can receive the instantiated output template from output template processor 19 as at 32, as shown in FIGS. 2 and 4.

FIG. 5 illustrates the sharing of cross-domain objects obtained from their corresponding Conceptual Framework/Knowledge Set 5 as well as serialized data that has been generated by an instance of a Product Configuration System 4. One important aspect of the present invention is that a domain expert does not require the expertise of a software engineer to construct a custom Conceptual Framework and corresponding Knowledge Set for his/her domain (e.g., window and door manufacturer's product line). Further, any conceptual framework and associated knowledge set, representing a set of products, generated according to the present invention can be used in a any combination within an instance of a universal Product Configuration System so that product(s) from respective conceptual framework/knowledge set pairs can be shared, even if the conceptual frameworks are based on entirely different domains. FIG. 5 shows two sets of domain experts 1 constructing two Conceptual Frameworks/Knowledge Sets 5 (i.e., Conceptual Framework/Knowledge Set 1, N), which can be imported and/or drawn from respective instances of a Product Configuration System 4, as required by system users 3, for example. It will be appreciated that any number of Conceptual Frameworks/Knowledge Sets 1 . . . N can be envisioned and created/maintained by a number of domain experts 1 . . . N, and it will further be appreciated any number of system users 3 (i.e., System User(s) 1 . . . N) can also import framework/knowledge set pairs from other domains, as illustrated by the dashed lines in FIG. 5. Both instances of Product Configuration Systems 1, N can import the conceptual frameworks/knowledge sets from its own or the other system. In addition, each Product Configuration System instance allows a user to serialize any selected objects and their associated attributes. The Serialized Objects/Attributes 14 that either Product Configuration Systems 1 or N create may be de-serialized by either Product Configuration System 1 or N, as well, as illustrated by the bold and dotted lines in FIG. 5, for example.

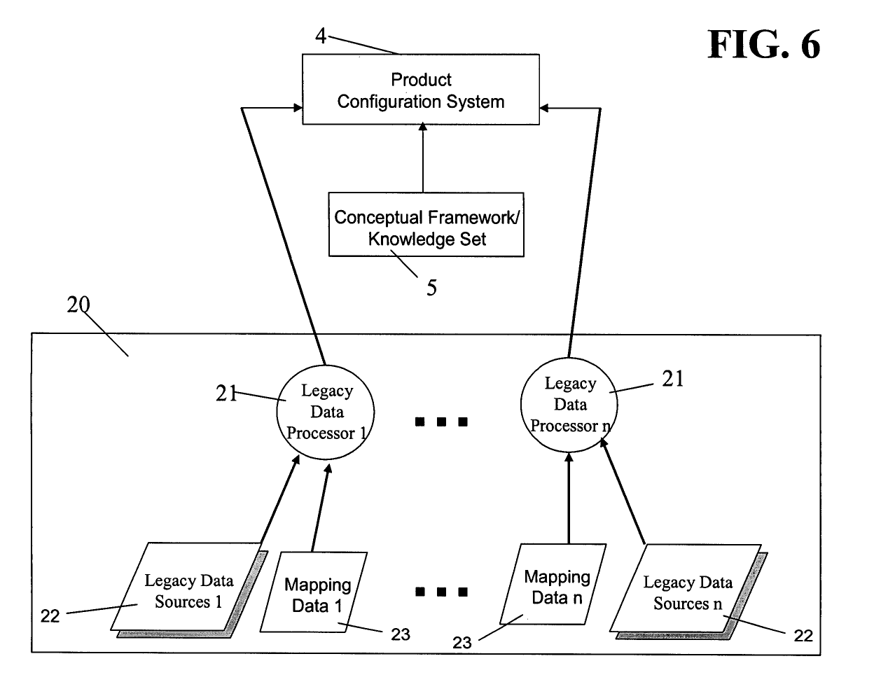

FIG. 6 illustrates a Product Configuration System 4 instance, incorporating the capability to import converted legacy domain data as objects, which can then be manipulated and utilized by any Product Configuration System. The Legacy Data Processor 21 converts legacy domain data (i.e., from Legacy Data Source 22) into products/objects that are compatible with the architecture of the present invention, thus maintaining backward compatibility with legacy data. The Legacy Data Processor can be, in one embodiment of the present invention, a small software module that is customized to a particular Legacy Data Source. The Legacy Data Processor processes (e.g., parses) a given Legacy Data Source and then constructs the objects that are used by an instance of a Product Configuration System 4, as shown in FIG. 6. Since objects in the preferred embodiment are XML elements, during processing of the Legacy Data Source 22, the associated Mapping Data 23 can be used to tag the data into the corresponding XML elements. These constructed objects can be operated upon in similar fashion to ones constructed as the user navigates a particular Conceptual Framework 6 and as such may become part of a given Output 13, as illustrated in FIG. 2, for example. Anyone skilled in the art may substitute any process that can convert legacy domain data into objects that are compatible with the architecture described in this invention.

The Conceptual Framework/Knowledge Set 5 is a separate component from an instance of a Product Configuration System 4 as shown in FIG. 2. A core component is the System Controller 8 that interfaces directly with the Interface Builder 10, Knowledge Engine 11, Output Template Processor 19, and Output Engines 12. The System Controller 8 provides for importing and/or processing the desired Conceptual Framework 6 and the Knowledge Engine 11 imports the associated Knowledge Set 7. The Interface Builder 10 then dynamically generates an appropriate interface (i.e., Dynamically Generated Interface 9) based on what product/attribute(s) is selected within the conceptual framework and this interface is further constrained by knowledge that is applied by the Knowledge Engine 11. The System Controller 8 receives user input from the Dynamically Generated Interface 9 as well as sends back data provided by this process or other processes (e.g., Knowledge Engine 11).

The System Controller 8 allows the user to select an Output Template 18 that can be applied to the selected products/attributes via the Output Template Processor 19, which will modify the output data sent to the Output Engine 12 that in turn will affect the content of the Output 13. The output data includes valid product(s) and their associated attributes as well as optionally additional contextual content. The System Controller 8 is also responsible for serializing/de-serializing selected Products/Attributes 14.

The Output Template Generator 17 allows the domain expert(s) and/or system user(s) 3 to generate an output template(s) 18, as illustrated in FIG. 4, that can then be applied to the selected products/attributes for the purpose of affecting the content of a particular type of Output 13.

As described elsewhere herein, any conceptual framework and its associated knowledge set created by an implementation of this invention can be shared (i.e., within any product configuration system) with other conceptual frameworks and their associated knowledge sets with another implementation of this invention.

It is further envisioned by the present invention that the system user(s) 3 can easily be kept up-to-date with a set(s) of desired products (i.e., represented by its respective conceptual framework and associated knowledge set) through various currently available technologies. For example, a system user can have a desired set(s) of products automatically updated by first subscribing to a channel from a producer of the respective conceptual framework and associated knowledge set data, and then when their instance of a Product Configuration System 4 is invoked, it automatically “pulls” the set(s) of desired products from the producer(s).

As described above there exist functional and/or structural variations for all the main components and subcomponents in this invention. Anyone skilled in the art may substitute any combination of these functional and/or structural variations to produce a system that does the following: 1. Allows a domain expert 1 to generate a data model that specifies valid products/attributes from a particular domain that is paired with knowledge that specifies additional constraints on this universe of products, attributes and their relations; 2. interacts with a user to allow that user to navigate this universe of products, attributes, and their relations to select valid products through an interface that may be dynamically generated; 3. allows a user to generate arbitrary output (e.g., ad-hoc and pre-defined reports) via an Output Engine 12 and/or Output Template 18 mechanism or any of its structural and/or functional variations; 4. allows a user to serialize/de-serialize any of the selected products/attributes; and 5. allows any conceptual framework and its associated knowledge set created by any variation of this invention to be shared (i.e., within any product configuration system) with one another.

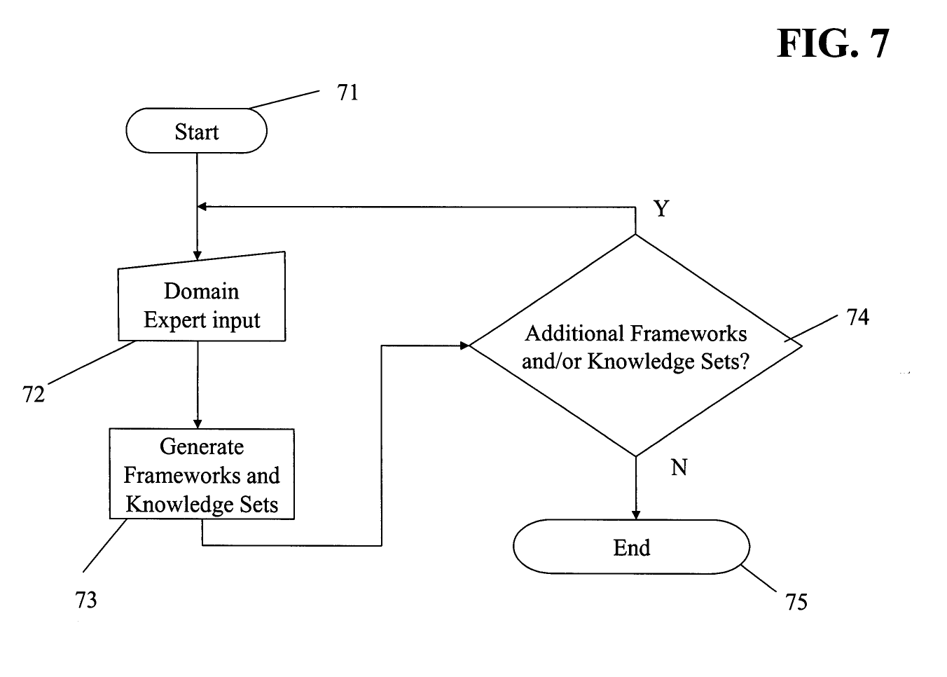

FIG. 7 provides a flowchart for the operation of the Conceptual Frameworks/Knowledge Sets Generator. Upon starting as at 71, Domain Expert input is received as at step 72 in order to generate, at step 73, a conceptual framework 6 and a corresponding knowledge set 7 for each domain (e.g., window and door manufacturer's product line) specified. If additional frameworks or knowledge sets are to be entered, as determined at step 74, the operation returns to step 71. However, if no further frameworks or knowledge sets are to be entered, the operation ends as at step 75.

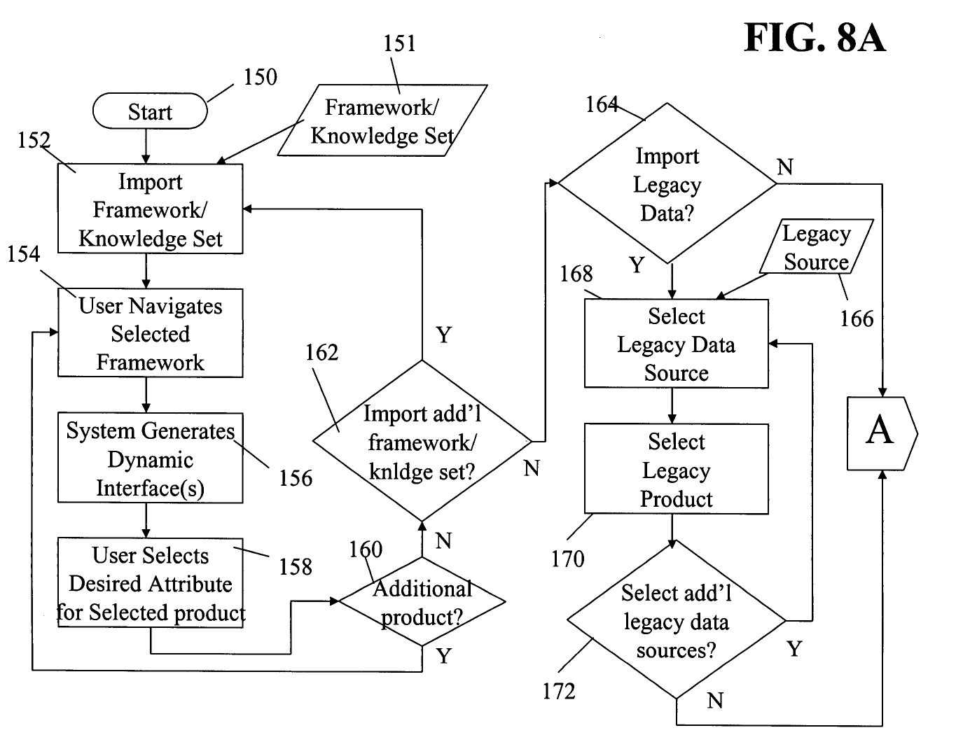

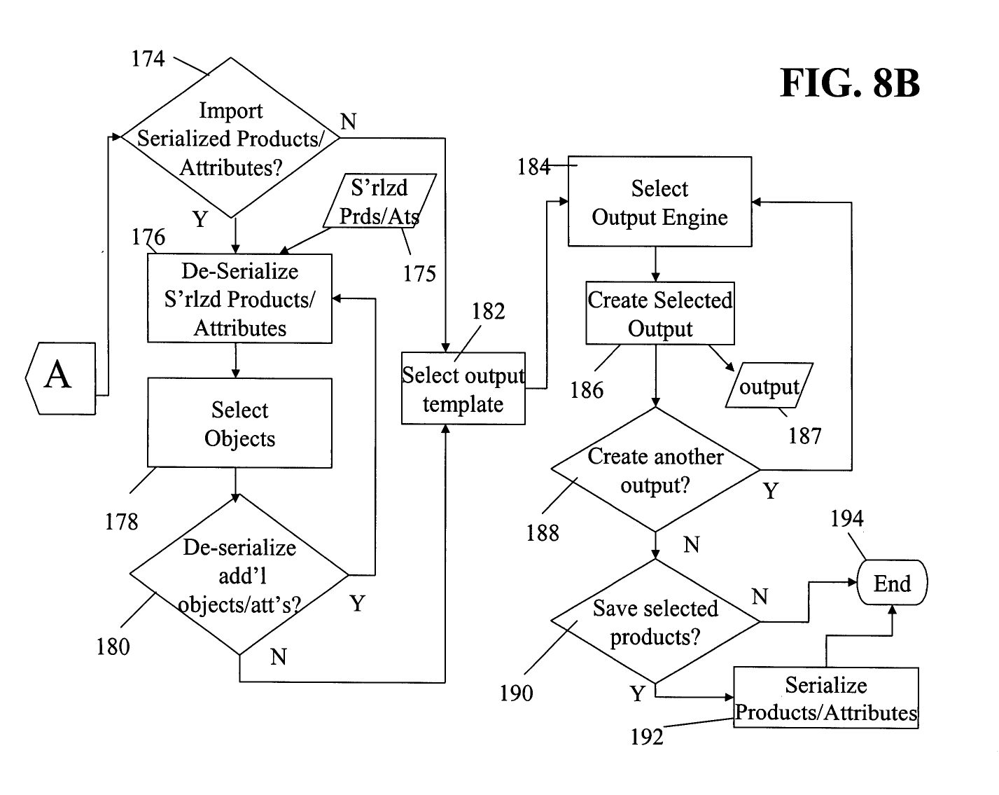

The Conceptual Framework/Knowledge Set 5 is, in one embodiment, a separate component from a Product Configuration System 4, as shown in FIG. 2, whose operation is illustrated by way of example in FIGS. 8A and 8B. Upon starting as at 150 in FIG. 8A, a stored framework/knowledge set 151 is imported as at step 152. The framework can be imported by the System Controller while the Knowledge Engine can import the associated Knowledge Set. The Interface Builder can allow the user to navigate the conceptual framework as at step 154, and can present a dynamic interface as at step 156 as products within the framework are selected/configured (i.e., constructed) as at step 158. In one embodiment, the Dynamically Generated Interface is farther constrained by knowledge that is applied by the Knowledge Engine. The domain knowledge (e.g., business logic) can also provide meaningful feedback on any actions (e.g., errors) a user may have taken while either navigating products within the conceptual framework or the selection of attribute(s) for the selected product. If additional objects are involved as determined at step 160, the operation returns to step 154. If additional frameworks/knowledge sets are involved as determined at step 162, the operation returns to step 152.

As at step 164, a user now has the choice of selecting a particular Legacy Data Source, which invokes its corresponding Legacy Data Processor and allows the user to select from a list of constructed products. If legacy data 166 is to be imported as at step 164, the legacy data source can be selected as at 168, a legacy object can be selected as at 170, and a determination can be made as at 172 as to whether additional legacy sources will be used. If no legacy data is to be imported at step 164, or if no further legacy data will be employed as at step 172, operation extends through connector A in FIG. 8A to step 174 in FIG. 8B.

At step 174, the user may then also select previously Serialized Products/Attributes 175 that can then be utilized by the Product Configuration System. Product/attributes can be de-serialized as at step 176, selected as at step 178, and if additional products/attributes are to be de-serialized as determined at step 180, the operation can return to step 176. If not, or if serialized objects/attributes are not to be imported as determined at step 174, the operation can flow to step 182 where an output template can be selected. The output template is applied to the selected products/attributes in order to modify the data sent to the Output Engine, which in turn will create the desired content for the particular type of Output. At step 184, an output engine is selected, and a selected output 187 is created at step 186. Output 187 can include, for example, the selected products/attributes as well as optionally additional contextual content. If another output is to be created at step 188, operation returns to step 184, and otherwise flows to step 190. At step 190, if selected products are to be saved, the products/attributes are serialized as at step 192; otherwise, operation ends as at step 194. In one embodiment, a user may de-serialize a previously serialized set of product(s)/attribute(s) in order to view or modify the desired set of product(s)/attributes(s).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

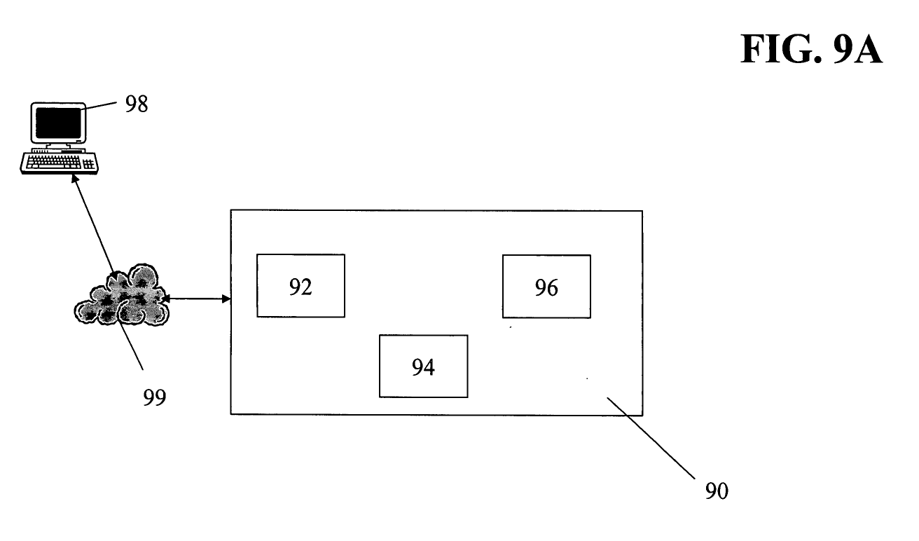

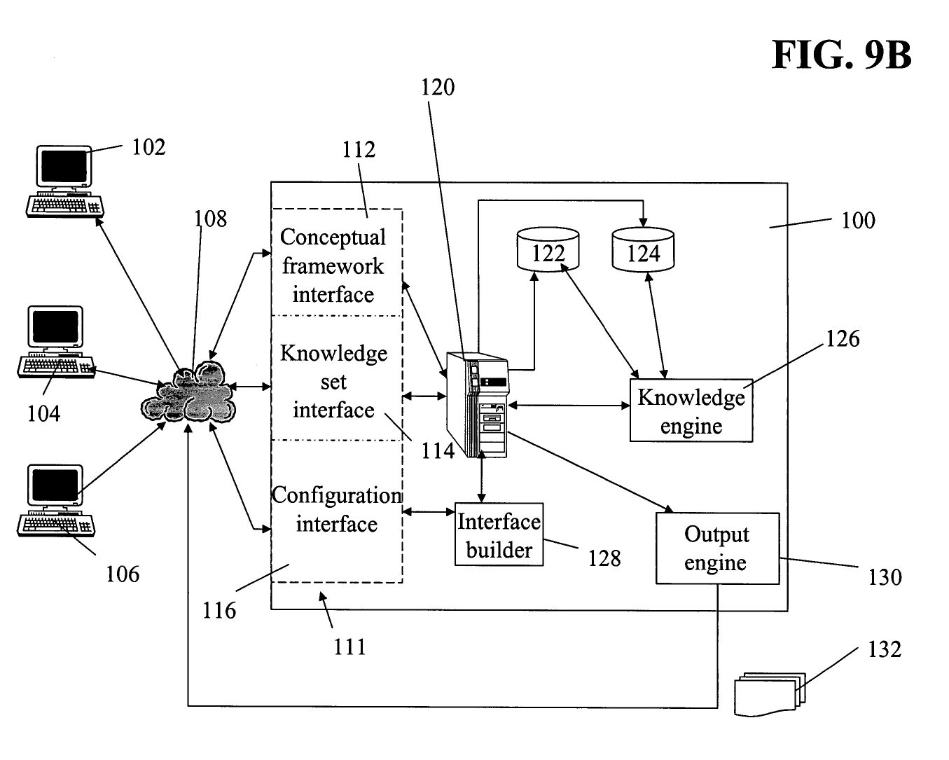

As shown in FIGS. 9A and 9B, the present invention can comprise, in one embodiment, a system 90 having a conceptual frameworks/knowledge set generator 92, a product configuration component 94 and an output template generator 96. A user 98, who can be a domain expert creating/maintaining a conceptual framework and its associated knowledge set for a particular domain which is then subsequently used by an instance of a product configuration system can interact with the system 90 over network 99, for example. In one embodiment, network 99 can be a publicly accessible network such as the Internet.

In this embodiment, the Conceptual Frameworks/Knowledge Sets Generator 92 is used by the domain expert to specify the conceptual framework (e.g., schema) for the set of products that are of importance from a particular domain(s). In one embodiment, the products or objects can come from more than one domain. The domain expert can also specify the knowledge (e.g., If-Then logic rules) used to add additional more complex constraints and logic to ensure only valid products can be selected and configured. In one embodiment, the conceptual framework contains a type of blueprint for all of the available products as well as basic constraints for those products, while the knowledge set specifies additional more complex constraints and logic to ensure that the products are correctly specified by the user.

The Product Configuration component 94 can be used by a user to import any number of Conceptual Frameworks/Knowledge Sets, and then to navigate the framework(s) to select desired products and to configure them in a desired fashion. The Product Configuration System can use the relevant conceptual framework and associated knowledge set to ensure only valid products can be selected and configured.

The Output Template Generator 96 can be employed by either the domain expert or other user to create templates which can be XML schemas, for example, and which specify what elements as well as their attributes would be contained in an actual output (e.g., report). The elements in the template can comprise representations of anything that is desired for a particular output. For example, if the output template represented the contents of a “Rough Opening Schedule”, which is used by a contractor to install windows or doors the customer purchased, some of the elements in that Rough Opening Schedule template could be: dealership information, customer name/address, and for each window or door that has been selected, display the description (e.g., double hung window), surface (e.g., wood), and rough opening (e.g., 27″×36″). Even though the selected products can contain many more attributes or specifications, the Rough Opening Schedule template may be provided with a limited number (e.g., three).

When the user selects a particular output type (i.e., template), that template can be instantiated with the actual values for the desired elements and then the resulting instantiated objects can be provided to an appropriate output engine (which is a component of the Product Configuration System, in one embodiment) to create the desired output.

The Universal Configuration System 90 as shown in FIG. 9A not only has the capability to configure products from multiple product lines within a particular domain but can also configure products across arbitrary domains, since the architecture of this concept operates in terms of objects, which can literally be anything. The semantics of those objects are determined by the domain expert as well as the output templates used for generating an actual output based on the objects from a particular domain or set of domains.

It will be appreciated that the representation and logic associated with a particular set of products is completely separated from the Product Configuration System which knows how to process those representations (i.e., conceptual framework) and logic (i.e., knowledge set). The templates used to represent the type of information contained within a particular output can also be separate as well as from the process (i.e., Output Template Generator) that creates them.

It will also be appreciated that the conceptual frameworks and associated knowledge sets, as well as other key aspects of this invention, can be based on an open, non-proprietary international standard, which is conducive to standardization for configuration systems. The conceptual frameworks in one embodiment of the invention are based on XML schema as are the output templates, and the objects that the Product Configuration System processes are XML elements.

As shown in the specific embodiment of FIG. 9B, users 102, 104 and 106 can interact with the system 100 of the present invention over network 108, which may be a publicly accessible network such as the Internet, for example. In an illustrative embodiment, User 102 can be a domain expert providing a conceptual framework through interface 112, user 104 can be the same or a different domain expert providing one or more knowledge sets through interface 114, and user 106 can be a subsequent user of the system such as a salesperson building a quote through interface 116. Interfaces 112, 114 and 116 can be provided as part of an interface component 111 as shown in FIG. 9B.

As further shown in FIG. 9B, a central processing component 120 is provided and component 120 can process information received from users 102, 104 through respective interfaces into respective framework data store 122 and knowledge set data store 124. Component 120 can also communicate with knowledge engine 126 and interface builder 128. Knowledge engine maintains the programming and logic necessary to determine valid products which may be selected by a user such as user 106, based on received and stored conceptual framework input and knowledge set input. Interface builder 128 allows dynamic interfaces to be built on the fly as a user interacts with the system. For example, a user 106 can view a first overall interface for a particular product domain, and then as the user makes selections, the interface builder can react to present the user with interfaces that allow only valid product and attribute selections. Output engine 130 is also provided in communication with processing component to produce output such as reports 132, which can be communicated through network 108 to users.

### ILLUSTRATIVE EMBODIMENTS OF THE INVENTION

Three examples of this invention are provided hereafter from the following domains: window and door domain in a quote-based context, “food and wine” domain, and “spacecraft telemetry” domain. These examples are merely intended to illustrate how this invention can conceivably be used in any domain and as such this invention is not limited to these three domains. Furthermore, the examples below specify that the relationships between the products are hierarchical but this invention allows that the products within the conceptual framework may have any relationship to each other, which is determined, solely by the actual domain (as well as its domain expert(s)) that is being modeled within the conceptual framework. The last example (i.e., spacecraft telemetry domain) illustrates that the output of an instance of a Product Configuration System 4 need not be a report per se, but could be something else entirely, which in this case is a software system.

### EXAMPLE 1

Let us suppose that domain expert(s) for window & door manufacturer A have used the Conceptual Frameworks/Knowledge Sets Generator 2 to construct a conceptual framework and its associated knowledge set for manufacturer A's product line which specifies the relationships for the window & door products with their associated specifications and any associated rules which are required to further constrain the set of valid window & door products and their specifications. In this example, the user of Universal Product Configuration System A can first navigate a hierarchical classification of manufacturer A's product line until the desired product is selected. Let us further suppose that manufacturer A has clad and wood products and that for their window products, it produces a line of casement windows which can be either a casement, casement picture, or French casement window. Below is the relevant portion of the hierarchy that the user would navigate:

```
Clad
    Windows
        Casements
            Casement
            Casement Picture
            French Casement
    Doors
        ...
Wood
    ...
```

In this example, a Universal Product Configuration System A user (e.g., a sales person working for a dealer who sells products for Manufacturer A's product line) selects a clad French Casement window with the ultimate goal of quoting it to a customer. Once the French Casement window is selected, the user interface is dynamically updated with the relevant specifications which the domain expert(s) had previously specified for manufacturer's A clad French Casement windows (i.e., via its conceptual framework/knowledge set). Default values specified by the domain expert(s) are used as initial values for the window's specifications. One of the specifications for this window is its call number.

When specifying Manufacturer A's window dimensions, a user can either use “call numbers” or specify its “rough opening”. Each window within Manufacturer A's product line will usually have different valid call numbers as well as different valid rough opening dimensions. The user interface is dynamically updated to allow a user to select either call number or rough opening width and/or height. In this example, when the user has selected the French Casement window, the user first selects call number width and height. The user interface is then automatically updated with a “combo box” for the call number width with possible values of 40, 48, and 56 as well as another “combo box” for the call number height with possible values of 32, 36, 40, 48, 56, 60, 64, and 72; the call number widths and heights were specified within the conceptual framework and its associated knowledge set for Manufacturer A's product line. In this example, the user selects a call number width of 40 and a call number height of 56. Each time the user makes any changes to the window, an image of the French Casement window is dynamically updated as well. Again, the domain expert(s), either in the conceptual framework and/or in the product line's associated knowledge set, specified information used to update a product's image.

Once the call number width and height have been selected, a rule specified by the domain expert is automatically applied which specifies that the rectangular grille width (i.e., lites wide) can range from 1 wide to 5 wide and that the grille height (i.e., lites high) can range from 1 high to 4 high. In this case the user interface dynamically displays a “combo box” which contains the various grilles which are may be applied to this window and when the rectangular grille is selected, two label and text field pairs are displayed as well: Lites High and Lites Wide labels and their corresponding text fields. Each of the corresponding text fields would automatically enforce the range of values for lites wide, and high, respectively. In this case the user selects a rectangular grille that is 2 lites wide by 4 lites high.

In likewise fashion the Universal Product Configuration System A user makes selections for the other specifications for the French Casement window, as well, such as its jamb depth, interior and exterior finish, etc. As the sales person selects options for the window, rules may be applied which automatically adjust and set the cost for each option.

Once the sales person is satisfied that the window is specified according to the customer's wishes, s/he can select a report in order to print the specifications in a proposal form for the customer to sign off on. A default set of report types (i.e., Output Templates 18) can be specified by the domain expert for Manufacturer A, but the user of the Universal Product Configuration System A has the option of specifying ad hoc reports as well. Pre-defined and ad hoc reports can be created by the Output Template Generator 17, which will generate the desired Output Template 18 that the user can later select in order to create the specified report output. Thus, when the sales person selects a particular report type (i.e., Output Template 18), it is automatically applied to the selected windows and doors to create the specified report. Suppose the customer wants to have the dealer install the French Casement window in his residence. The sales person can specify that the total for the French Casement window also includes a labor charge and that the report also includes a section after the proposal title entitled “Scope of Work” which contains information detailing exactly what work will be accomplished by the dealer. So in this case the sales person selects the Installed Sales Report (i.e., Installed Sales Output Template), which displays the French casement's specifications as well as the labor cost, “Scope of Work”, etc. Lastly, the sales person saves the quote, which contains the French Casement window with all of its specifications to a file that may be further modified at a later date.

The customer looks at the proposal but decides the window is too tall and requests that the sales person change the call number height to the next lowest one which would be a call number height of 48. The sales person re-opens the quote file and makes the requested change but a rule automatically is applied which changes the rectangular grille height to 3 lites high and a message appears to the sales person which says “Rectangular grille height was changed to 3 lites high since the call number height was reduced from 56″ to 48″. In addition, the text field associated with the “Lites High” label would automatically enforce the range of values from 1-3, inclusive.

Lastly, let's suppose that domain expert(s) for window and door manufacturer B, uses the Conceptual Frameworks/Knowledge Sets Generator to construct an analogous conceptual framework and corresponding knowledge set for manufacturer B's product line. The above sales person could use the Universal Product Configuration System A to import the conceptual framework and corresponding knowledge set for Manufacturer B's product line and quote to a customer any of the products contained therein (likewise a user of Universal Product Configuration System B could do the same for Manufacturer A's product line). In fact, any manufacturer's conceptual framework/knowledge set could be shared (i.e., within any Universal Product Configuration System) with any other manufacturer's conceptual framework/knowledge set that was created/maintained with the Conceptual Frameworks/Knowledge Sets Generator 2. Furthermore, any of the quotes that were created (i.e., serialized) by any of the Universal Product Configuration Systems could be processed and modified by any of the other Universal Product Configuration Systems.

### EXAMPLE 2

Another example, which will further illustrate this invention is applicable to any domain, could be a system that is designed to select a meal with an appropriate wine. The meal may also include an appetizer(s) (i.e., hors d'oeuvres) and dessert along with an entrée. Suitable domain expert(s) for this system would be new and old world wine experts and chefs who specialize in vegetarian, red meat, poultry and seafood meals. These experts would use the Conceptual Frameworks/Knowledge Sets Generator 2 to specify a conceptual framework for products (i.e., appetizers, desserts, entrées, and wines) and their associated attributes in this domain and their relationship to each other as well as any applicable knowledge that would be necessary to allow a user of such a system to select appropriate meals and wines.

For example, a user of such a Product Configuration System (i.e., in this domain and in this context, it would appear to function as a virtual “Menu & Wine System Selector”) might initially navigate a hierarchy of meals as follows:

```
Vegetarian
    Vegan
    ...
Red meat
    Beef
    Lamb
    Pork
Poultry
    Chicken
    Turkey
    Pheasant
Sea Food
    ...
```

When the virtual “Menu & Wine System Selector” user selects a particular category of meal (e.g., Lamb), the user interface would automatically be updated with valid (as determined by the domain expert(s)) appetizers, entrées, desserts and wines. For example, if the virtual “Menu & Wine System Selector” user selects Roasted Lamb Chop as the desired entrée, then an option for “Toppings” might appear where the user could select Orange Blossom Sauce. Once these selections have been made, the list of wines would be dynamically updated and the user could then, for example, select the Chateau Benoit Pinot Noir 2000 as the desired wine for her meal. Lastly, after the user has selected the desired menu and wine, she would then select a “report” which might include recipes for the selected menu items as well as the wine selection and how it should be prepared and served.

### EXAMPLE 3

In this last example, suppose that we want to create a system that would allow a spacecraft telemetry specialist to construct a software telemetry system for a particular spacecraft. Let's suppose that telemetry systems in general are composed of subcomponents A, B, C, and D and that each of these subcomponents may have other components as well. Furthermore, there may be any number of variations for each of these components that a domain expert (e.g., software engineers who design and build spacecraft telemetry systems) would be skilled and familiar with in order to integrate these components into a spacecraft telemetry system, which would meet the requirements for a particular spacecraft(s).

A domain expert(s), who is skilled in designing and building spacecraft telemetry systems, could use the Conceptual Frameworks/Knowledge Sets Generator to construct a conceptual framework which would specify the products (i.e., software subcomponents that serve as building blocks when constructing a telemetry system) and their associated attributes, as well as the software components' relationships to each other (i.e., Conceptual Framework 6). In addition, the spacecraft telemetry system designer domain expert would specify any associated rules which would further constrain the valid set of subcomponents for a particular spacecraft telemetry system. The rules (i.e., Knowledge Set 7) the domain expert specifies could also be used to provide any “glue code” which is necessary in order to “glue” (i.e., integrate) software components together.

Once the spacecraft telemetry system designer domain expert has used the Conceptual Frameworks/Knowledge Sets Generator 2 to construct the conceptual framework 6 and associated knowledge set 7, other more novice users (e.g., spacecraft telemetry specialist) could use such a Product Configuration System (i.e., in essence the present invention in this context would appear to function as a virtual “Spacecraft Telemetry System Builder”) to import the relevant conceptual framework and knowledge set in order to construct an actual telemetry system for a particular spacecraft(s). As the virtual “Spacecraft Telemetry System Builder” user selects software components to be used in constructing a telemetry system for his spacecraft, the user interface is dynamically updated with corresponding additional subcomponents and their associated attributes. As the user selects the various subcomponents, knowledge could automatically be applied (as specified in the associated knowledge set) which further constrains the valid set of subcomponents/attributes. Lastly when the user has finished specifying the subcomponents/attributes which make up his telemetry system, he would direct the virtual “Spacecraft Telemetry System Builder” to integrate all of the components into the complete spacecraft telemetry system for his spacecraft by selecting the appropriate Output Engine 12 to generate the “software system” Output 13.

It will be apparent to one skilled in the art that any computer system that includes suitable programming means for operating in accordance with the disclosed methods also falls well within the scope of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system. The present invention can further run on a variety of platforms, including Microsoft Windows™, Linux™, Sun Solaris™, HP/UX™, IBM AIX™ and Java compliant platforms, for example.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

1. A computer-assisted universal product configuration system, comprising:
a display device;
an input device;
a domain framework interface for receiving at least one conceptual framework pertaining to at least one product domain, said framework defining a universe of valid products pertaining to said at least one product domain, said framework including a plurality of data types, at least one data relationship expression and at least one data constraint; and
a processing unit operable to:
derive at least one valid product selection option based upon said received conceptual framework and said received knowledge set; and
construct a visual interface for display on said display device and pertaining to said valid product selection option, said visual interface responsive to input received from said input device.

2. The system of claim 1 further including a domain knowledge interface for receiving at least one domain expert knowledge set pertaining to said at least one product domain, said knowledge set including at least one logic constraint.

3. The system of claim 1 wherein said product domain pertains to an industry of multiple manufacturers.

4. The system of claim 1 wherein said input device receives domain expert instructions for customizing a product selection display on said visual interface.

5. The system of claim 1 wherein said processing unit is operable to dynamically construct visual interfaces based on said input received from said input device.

6. The system of claim 1 wherein said input device receives input in the form of a request for a valid product.

7. The system of claim 1 wherein said input device receives input in the form of a selection of a valid product from said at least one derived valid product selection option.

8. The system of claim 1 wherein said processing unit is further operable to generate output based on said input received from said input device and pertaining to said valid product.

9. The system of claim 8 wherein said output is taken from the group consisting of: report, price quote, bid, system augmentation, product configuration.

10. The system of claim 2 wherein said framework or said knowledge set further includes a plurality of logic constraints for valid product selection.

11. A computer-assisted method for providing a universal product configuration system, comprising the steps of:
providing a display device;
providing an input device;
providing a domain framework interface for receiving at least one conceptual framework pertaining to at least one product domain, said framework defining a universe of valid products pertaining to said at least one product domain, said framework including a plurality of data types, at least one data relationship expression, and at least one data constraint; and
providing a processing unit operable to:
derive at least one valid product selection option based upon said received conceptual framework and said received knowledge set; and
construct a visual interface for display on said display device and pertaining to said valid product selection option, said visual interface responsive to input received from said input device.

12. The method of claim 11 including the further step of providing a domain knowledge interface for receiving at least one domain expert knowledge set pertaining to said at least one product domain, said knowledge set including at least one logic constraint.

13. The method of claim 11 wherein said product domain pertains to an industry of multiple manufacturers.

14. The method of claim 11 wherein said input device receives domain expert instructions for customizing a product selection display on said visual interface.

15. The method of claim 11 wherein said processing unit is operable to dynamically construct visual interfaces based on said input received from said input device.

16. The method of claim 11 wherein said input device receives input in the form of a quote request for a valid product.

17. The method of claim 11 wherein said input device receives input in the form of a selection of a valid product from said at least one derived valid product selection option.

18. The method of claim 11 wherein said processing unit is further operable to generate output based on said input received from said input device and pertaining to said valid product.

19. The method of claim 18 wherein said output is taken from the group consisting of: report, price quote, bid, system augmentation, product configuration.

20. The method of claim 12 wherein said framework or said knowledge set further includes a plurality of logic constraints for valid product selection.

21. A computer-assisted system for providing a universal product configuration system operable across multiple product domains, comprising:
a display device;
an input device;
a domain framework interface for receiving at least one conceptual framework pertaining to a first product domain and at least one conceptual framework pertaining to a second product domain, said frameworks defining respective first and second universes of valid products pertaining respectively to said first and second product domains;
a domain knowledge interface for receiving at least one domain expert knowledge set for each of said first and second product domains, said knowledge sets each including at least one logic constraint pertaining to a product configuration associated with said respective product domains; and
a processing unit operable to:
derive at least one valid product selection option for each of said product domains based upon said respective received conceptual frameworks and said respective received knowledge sets;
construct a visual interface for display on said display device and pertaining to said valid product selection options, said visual interface responsive to input received from said input device; and
derive logic for comparing input received from said input device pertaining to a proposed configuration with said valid derived product selection option for each of said product domains to assess the validity of said proposed configuration.

22. The system of claim 21 wherein said proposed configuration pertains to said first product domain and said second product domain.

23. The system of claim 21 wherein said domain framework interface includes a data filter component for converting and importing legacy data from legacy data sources.

24. A computer-assisted method for providing a universal product configuration system operable across multiple product domains, comprising the steps of:
providing a display device;
providing an input device;
providing a domain framework interface for receiving at least one conceptual framework pertaining to a first product domain and at least one conceptual framework pertaining to a second product domain, said frameworks defining respective first and second universes of valid products pertaining respectively to said first and second product domains;
providing a domain knowledge interface for receiving at least one domain expert knowledge set for each of said first and second product domains, said knowledge sets each including at least one logic constraint pertaining to a product configuration associated with said respective product domains; and
providing a processing unit operable to:
derive at least one valid product selection option for each of said product domains based upon said respective received conceptual frameworks and said respective received knowledge sets;
construct a visual interface for display on said display device and pertaining to said valid product selection options, said visual interface responsive to input received from said input device; and
derive logic for comparing input received from said input device pertaining to a proposed configuration with said valid derived product selection option for each of said product domains to assess the validity of said proposed configuration.

25. The method of claim 24 wherein said proposed configuration pertains to said first product domain and said second product domain.

26. The method of claim 24 wherein said domain framework interface includes a data filter component for converting and importing legacy data from legacy data sources.

27. A computer-assisted system for providing a universal product configuration system, comprising:
a domain framework interface for receiving a plurality of conceptual frameworks pertaining to a plurality of product domains, said frameworks defining a universe of valid products pertaining to said product domains;
a domain framework storage component for storing said frameworks;
a domain knowledge interface for receiving a plurality of domain expert knowledge sets, each of which pertains to a respective one of said product domains, said knowledge sets each including at least one logic constraint pertaining to a product configuration associated with said respective product domain; and
a domain knowledge storage component for storing said knowledge sets;
an input device for receiving instructions to select at least two stored frameworks, and to receive at least one product selection in connection with each of said selected frameworks; and
a processing unit operable to determine whether said at least one product selection is a valid selection option for each of said selected frameworks based upon said stored knowledge sets corresponding to said selected frameworks.

28. The system of claim 27 wherein said processing unit is further operable to generate output based on said input received from said input device and pertaining to said valid product.

29. The system of claim 28 wherein said output can be imported into an external system.

30. A computer-assisted method for providing a universal product configuration system, comprising the steps of:
providing a domain framework interface for receiving a plurality of conceptual frameworks pertaining to a plurality of product domains, said frameworks defining a universe of valid products pertaining to said product domains;
providing a domain framework storage component for storing said frameworks;
providing a domain knowledge interface for receiving a plurality of domain expert knowledge sets, each of which pertains to a respective one of said product domains, said knowledge sets each including at least one logic constraint pertaining to a product configuration associated with said respective product domain; and
providing a domain knowledge storage component for storing said knowledge sets;
providing an input device for receiving instructions to select at least two stored frameworks, and to receive at least one product selection in connection with each of said selected frameworks; and
providing a processing unit operable to determine whether said at least one product selection is a valid selection option for each of said selected frameworks based upon said stored knowledge sets corresponding to said selected frameworks.

31. The method of claim 30 wherein said processing unit is further operable to generate output based on said input received from said input device and pertaining to said valid product.

32. The method of claim 31 wherein said output can be exported into an external system.

33. A method for generating a report for products across multiple product domains, comprising the steps of:
receiving and storing a plurality of conceptual frameworks pertaining to a plurality of product domains, said frameworks defining a universe of valid products pertaining to said product domains;
receiving and storing a plurality of domain expert knowledge sets pertaining to said product domains, said knowledge sets each including at least one logic constraint pertaining to a product configuration associated with said respective product domains;
receiving a report request for a product configuration involving a product or products in two or more product domains; and
upon the requested product configuration being determined a valid configuration, providing a report for said requested configuration.

34. The method of claim 33 wherein said report is represented according to one of the group consisting of: text file, XML file, PDF document, video stream, drawing, quote, numerical.

35. The method of claim 33 wherein said report is not predefined.

36. A computer-assisted window and door industry quote configuration system, comprising:
a display device;
an input device;
an interface for receiving window and door industry framework defining a universe of valid products pertaining to the window and door industry;
a framework storage component for storing said framework;
an interface for receiving an expert knowledge set pertaining to said window and door industry, said knowledge set each including at least one logic constraint pertaining to a door and window industry product configuration; and
a knowledge storage component for storing said knowledge set; and
a processing unit operable to:
derive at least one valid product selection option based upon said received framework and knowledge set; and
construct a visual interface for display on said display device and pertaining to said valid product selection option, said visual interface responsive to input received from said input device.

37. The system of claim 36 wherein said framework receiving interface can import a plurality of product lines.

38. A computer-assisted universal product configuration system, comprising:
a conceptual frameworks knowledge set generator for receiving a domain-specific data model and associated knowledge set pertaining to at least one product, and generating a framework/knowledge set associated therewith;
a product configuration system capable of accessing said generated framework/knowledge set, retrieving at least a portion of said generated framework/knowledge set, and presenting said retrieved portion for navigation by at least one user;
an output template generator for creating at least one template; and
an output template processor for receiving an output template and at least object data and subsequently outputting an instantiated output template with said retrieved portion.
